(19) United States
(12) Patent Application Publication
(10) Pub. No.: US 2011/0209673 A1
(43) Pub. Date: Sep. 1, 2011

(54) ANIMAL LEG COVER

(76) Inventor: Susan Joan Weyerman, Sparta, MI (US)

(21) Appl. No.: 13/032,414

(22) Filed: Feb. 22, 2011

Related U.S. Application Data
(60) Provisional application No. 61/306,078, filed on Feb. 19, 2010.

(51) Int. Cl. A61D 9/00; A01K 13/00

(52) U.S. Cl. 119/856; 119/850

(57) ABSTRACT

An animal leg cover that has two tubular portions that fit securely over two legs, front or rear, of an animal and is secured in place a strap over the animal's body. The cover can be comprised of two separate removably connected straps.

### RELATED APPLICATION

This application claims priority from provisional patent application filed on 19 Feb. 2010, bearing application No. 61/306,078.

### GOVERNMENT RIGHTS

This invention was not made with Government support. The Government does not have any rights in this invention.

### BACKGROUND OF THE INVENTION

What is needed is a device to cover a wound on a leg of an animal that cannot be removed by pulling at the covering.

In addition, a device that can fit on four legged animals that have a variety of leg and body sizes is needed.

These and other features, aspects and advantages of the present invention will become better understood with reference to the following drawings, description and claims.

### BRIEF DESCRIPTION OF THE DRAWINGS

FIG. 1 is a pictorial view of one embodiment of the present invention;

FIG. 2 is a pictorial of an embodiment of one embodiment of the present invention on a dog;

FIG. 3 is a side pictorial of an embodiment of the present invention;

FIG. 4 is a pictorial of an embodiment of the present invention;

FIG. 5 is a pictorial of another embodiment of the present invention top view; and

FIG. 6 is a pictorial of another embodiment of the present invention side view.

### DETAILED DESCRIPTION OF THE INVENTION

The following detailed description is of the best currently contemplated modes of carrying out the invention. The description is not to be taken in a limiting sense, but is made merely for illustrating the general principles of the invention, since the scope of the invention is best defined by the appended claims.

### REFERENCE NUMERALS

10 protective animal leg cover

20 first member

30 second member

40 first member tubular portion

50 second member tubular portion

60 attachment member

70 collar extension

80 means to attach collar extension to attachment member 60

90 means to attach collar extension to collar

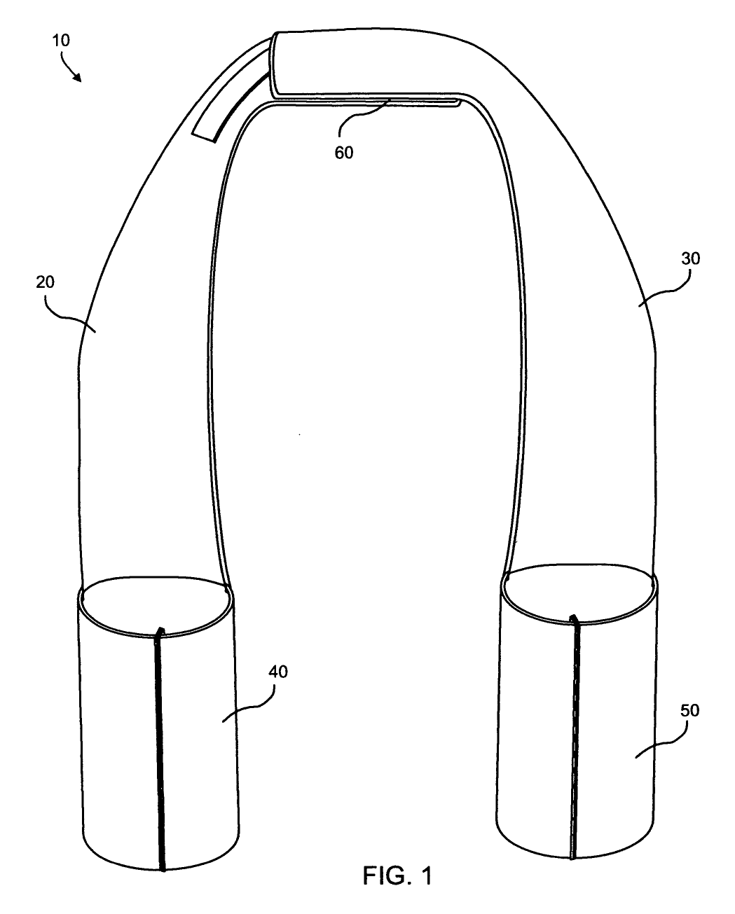

FIG. 1 illustrates an embodiment of the present invention, animal leg cover 10, also referred to herein as a leg cover 10. The leg cover may have a first member 20 having a first member tubular portion 40. The leg cover 10 may be made of a cloth or foam material. The leg cover 10 may also have a second member 30 having a second member tubular portion 50.

The first member 20 may be connected to the second member 30 by a attachment member 60. In one embodiment, the attachment member 60 may be a Velcro strap on the first member 20, and a Velcro receiving strap on the second member 30 so that the Velcro portion of the Velcro portion of the first member 20 can be removably attached to the Velcro receiving strap on the second member 30

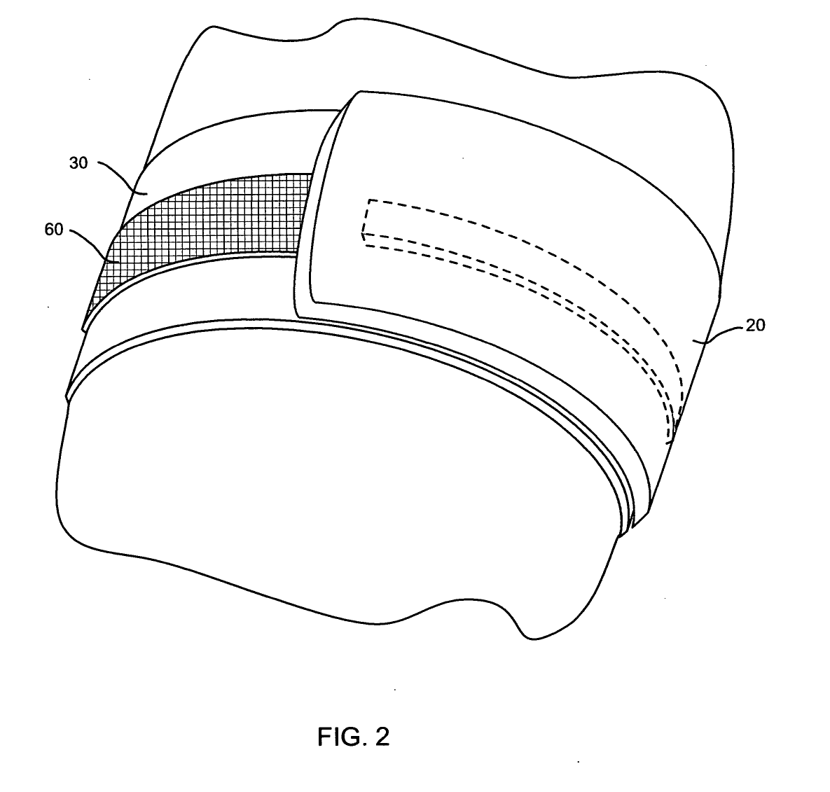

As illustrated in FIG. 2, the Velcro strap may be located on a top side of the first member 20. The Velcro receiving strap may be located on the bottom side of the second member 30.

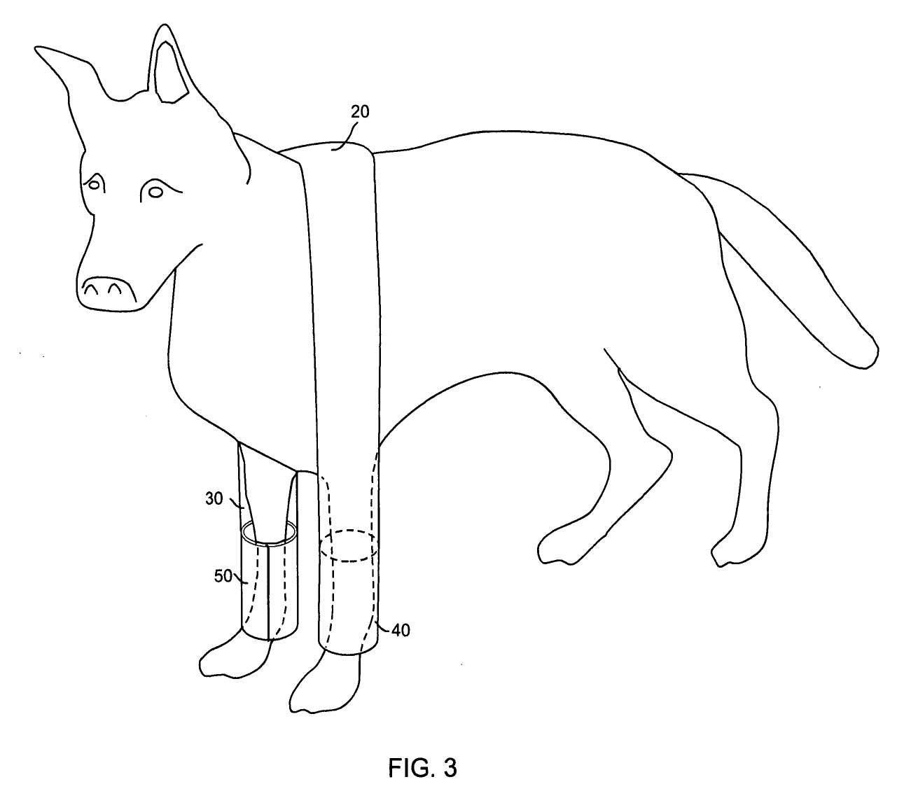

FIG. 3 illustrates an embodiment showing what the first member tubular portion 40 and the second member tubular portion 50 would fit onto an animal's leg. The respective tubular portion 40, 50 may extend from the foot to the shoulder if on a front leg, or from the foot to the waist if on a rear leg. The upper portion of the respective tubular portion 40, 50 may be integral with the respective first member 20 or second member 30.

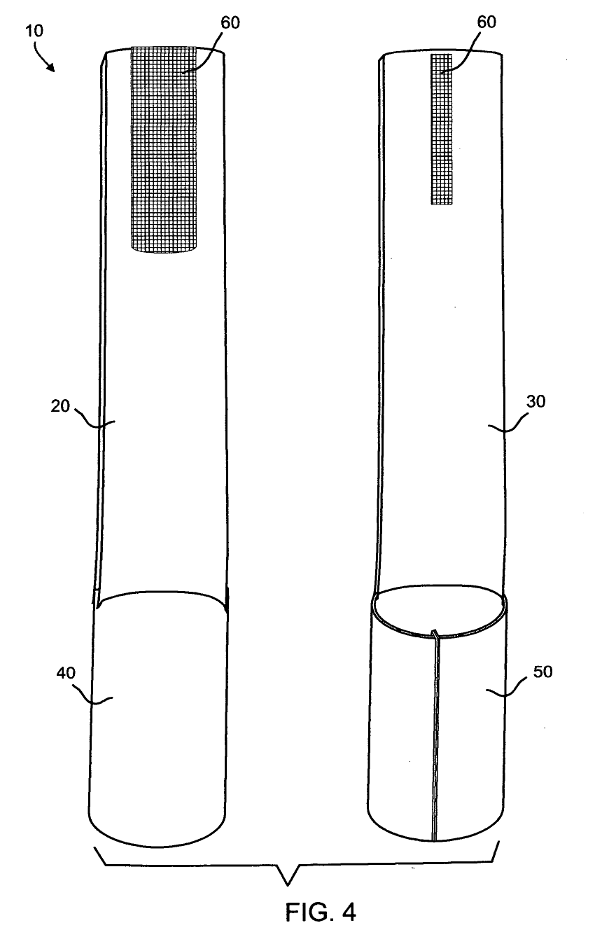

FIG. 4 illustrates an embodiment of the first member 20 not connected to the second member 30. Also illustrated is the attachment member 60 of the first member 20 and second member 30, and the respective tubular portions 40, 50.

Another embodiment may have an elastic portion to hind leg protectors for a better fit. In one embodiment, the elastic portion may be at the top of a seam of tubular portions 40 and 50.

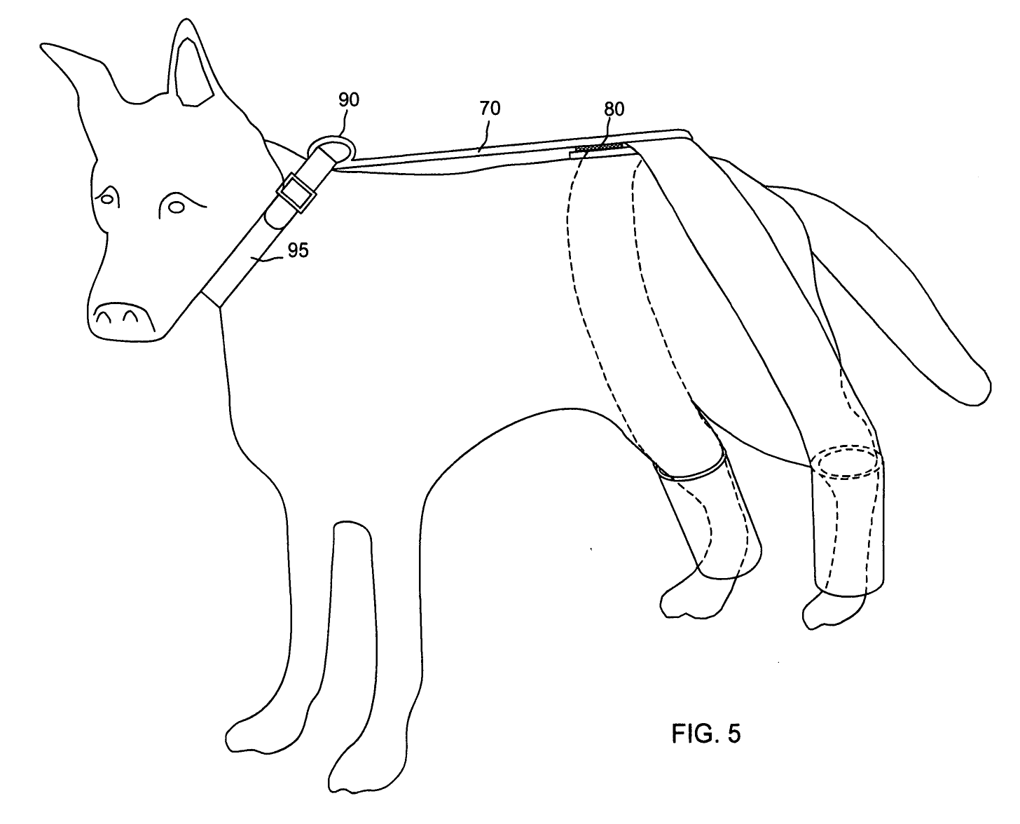

As illustrated in FIGS. 5 and 6, in one embodiment, the attachment member 60 of the first member 20 and second member 30 have a collar extension 70 connected to it by means to attach collar extension to the attachment member 80. The collar extension 70 may be connected to a dog collar by means to attach collar extension to collar 90. The means 90 may be a carbiner hook that is removably connected to both the collar and a front portion of the collar extension 70. The means 90 may also be a Velcro strap, or a snap, or button.

Alternatively, the collar extension 70 may be a fleece fabric, enabling the user to fold the front end over to make a loop via a Velcro attachment (not illustrated). The dog's collar can then be removably disposed through the loop. The opposite end, or rear end of the collar extension 70 may have Velcro on the top and bottom. The rear end of the collar attachment 70 may be used by removably attaching the attachment member 60 of either the first member 20 or second member 30 to the rear end of the collar extension 70, and then removably attaching the other attachment member 60 of either the second member 30 or first member 20, to the top of the collar extension 70. Thus the rear end of the collar extension 70 may be sandwiched between the first member 20 and second member 30, at the location of the attachment member 60 via the Velcro straps that removably engage with the attachment member 60 of both the first member 20 and second member 30.

In one embodiment, the collar extension 70 may be connected to the attachment member 60 by means to attach collar extension to attachment member 80.

In another embodiment, the first member tubular portion 40 and second member tubular portion 50 may have the bottom end stitched closed to protect the foot, similar to a sock (not shown).

It should be understood, of course, that the foregoing relates to exemplary embodiments of the invention and that modifications may be made without departing from the spirit and scope of the invention as set forth in the following claims.

I claim:

1. An animal leg cover (10), comprising:
a first member (20) having a first member tubular portion (40) and having an attachment member (60);
a second member (30) having a second member tubular portion (50) and having an attachment member (60);
whereby said first member tubular portion (40) can be fitted around an animal's first leg, and said second member tubular portion (50) can be fitted around an animal's second leg, and said first member (20) can be removably connected to said second member (30) via an attachment member (60) whereby said first member tubular portion (40) and said second member tubular portion (50) remain in a substantially fixed position on the front two legs of a living being that typically walks on four legs.

2. The apparatus of claim 1, further comprising:
a collar extension (70) having a front end removably attached to a collar by a means to attach collar extension to collar (90);
said collar extension (70) having a rear end removably attached to said attachment member (60) via a means to attach collar extension to attachment member (60) when said first member (20) and said second member (30) are removably attached to the rear legs of a living being that typically walks on four legs.

3. The apparatus of claim 1, wherein said first member (20), said second member (30), said first member tubular portion (40), said second member tubular portion (50) are made of a stretchable material.

4. The apparatus of claim 3, wherein said stretchable material is fleece fabric.
